(19) United States
(12) Patent Application Publication
(10) Pub. No.: US 2001/0000930 A1
(43) Pub. Date: May 10, 2001

(54) Crush-resistant polymeric microcellular wire coating

(76) Inventor: Roland Y. Kim, Somerville, MA (US)

Correspondence Address: Timothy J. Oyer, Wolf, Greenfield & Sacks, P.C., 600 Atlantic Avenue, Boston, MA, 02210, US

(21) Appl. No.: 09/726,522

(22) Filed: Nov. 30, 2000

Related U.S. Application Data
(62) Division of application No. 09/060,499, filed on Apr. 15, 1998.
Application No. 09/060,499 is a continuation-in-part of application No. 09/258,625, filed on Feb. 26, 1999.
Application No. 09/258,625 is a continuation of application No. PCT/US97/15088, filed on Aug. 26, 1997.
(60) Provisional application No. 60/024,623, filed on Aug. 27, 1996.
(60) Provisional application No. 60/026,889, filed on Sep. 23, 1996.

(51) Int. Cl. B32B 1/00; B32B 3/00; D03D 3/08; G02B 6/44

(52) U.S. Cl. 264/1.24; 428/603; 428/175; 428/220; 385/104; 385/107; 385/109; 174/250; 174/256; 174/128.1; 385/100

(57) ABSTRACT

A process for the extrusion of microcellular polymeric material onto data communications material such as wire and optical fiber is described. Electrical conductors and optical fibers coated with microcellular polymeric material exhibit unexpected strength sufficient to pass certain industry tests necessary for use in a variety of applications, even without an exterior coating of structurally-supporting polymeric material. Polymeric microcellular materials provided in contact with the electrical connectors for a variety of purposes are described where the strength of microcellular material provides required structural support.

### RELATED APPLICATIONS

1. This application is a divisional of U.S. Ser. No. 09/060,499, filed Apr. 15, 1998, which is a CIP of U.S. Ser. No. 09/258,625, filed Feb. 26, 1999, which is a continuation of PCT/US97/15088, filed Aug. 26, 1997. PCT US97/15088 is a PCT of U.S. Ser. No. 60/024,623, filed Aug. 27, 1996, U.S. Ser. No. 60/026,889, filed Sep. 23, 1996, and U.S. Ser. No. 08/777,709, filed Dec. 20, 1996.

### FIELD OF THE INVENTION

2. The present invention relates generally to polymeric wire coatings, and more particularly to a continuous method for extrusion of microcellular polymeric coatings onto wire and products made thereby.

### BACKGROUND OF THE INVENTION

3. Foamed polymeric materials are well known, and typically are produced by introducing a physical blowing agent into a molten polymeric stream, mixing the blowing agent with the polymer, and extruding the mixture into the atmosphere while shaping the mixture. Exposure to atmospheric conditions causes the blowing agent to gasify, thereby forming cells in the polymer. Under some conditions the cells can be made to remain isolated, and a closed-cell foamed material results. Under other, typically more violent foaming conditions, the cells rupture or become interconnected and an open-cell material results. As an alternative to a physical blowing agent, a chemical blowing agent can be used which undergoes chemical decomposition in the polymer material causing formation of a gas.

4. One class of polymer foams that can offer a variety of advantageous characteristics such as uniform cell size and structure, the appearance of solid plastic, etc. are microcellular foams. U.S. Pat. No. 4,473,665 (Martini-Vvedensky, et al.; Sep. 25, 1984) describes a process for making foamed polymer having cells less than about 100 microns in diameter. In the technique of Martini-Vvedensky, et al., a material precursor is saturated with a blowing agent, the material is placed under high pressure, and the pressure is rapidly dropped to nucleate the blowing agent and to allow the formation of cells. The material then is frozen rapidly to maintain a desired distribution of microcells.

5. U.S. Pat. No. 5,158,986 (Cha, et al.; Oct. 27, 1992) describes formation of microcellular polymeric material using a supercritical fluid as a blowing agent. In a batch process of Cha, et al., a plastic article is submerged at pressure in supercritical fluid for a period of time, and then quickly returned to ambient conditions creating a solubility change and nucleation. In a continuous process, a polymeric sheet is extruded, then run through rollers in a container of supercritical fluid at high pressure, and then exposed quickly to ambient conditions. In another continuous process, a supercritical fluid-saturated molten polymeric stream is established. The stream is rapidly heated, and the resulting thermodynamic instability (solubility change) creates sites of nucleation, while the system is maintained under pressure preventing significant growth of cells. The material then is injected into a mold cavity where pressure is reduced and cells are allowed to grow.

6. A constant need in interconnecting electronic devices is minimization of the delay in communicating information from one device to another. When the interconnection is done by metal wire, the speed of propagation of the signals depends upon the dielectric constant of the material that surrounds the wire. Speed is maximum when air surrounds the wire. However, for reasons of structural integrity and safety, an electrically insulating material must cover the wire. A solid layer of plastic is sturdy and has a high enough resistivity to be considered an electrical insulator. However, its dielectric constant is much greater than that of air. Signals carried by wires covered by solid plastic travel much slower than do those on bare wire.

7. Accordingly, some wire insulation techniques have involved extrusion of polymeric foam material onto wire. U.S. Pat. No. 3,981,649 (Shimano, et al.) describes an apparatus for producing a foamed thermoplastic resin on a wire. The apparatus includes an extruder having a barrel through which a thermoplastic resin is fed while being melted, and a gas injector for injecting a gas such as nitrogen into the molten resin in the barrel. The barrel is connected to a crosshead through which a wire is passed for forming foamed thermoplastic resin onto the wire.

8. U.S. Pat. No. 5,571,462 (Hashimoto et al) describes a technique for manufacturing an electric wire insulated with a foamed plastic. A foaming agent is introduced into a fluororesin in a molten state to allow the foaming agent to be dispersed in the molten resin. The molten resin is extruded onto a conductor wire to allow foaming. A fluorine-based foaming agent is used that contains as a main component at least one kind of a fluorocarbon having a molecular weight of about 338 to 488.

9. U.S. Pat. No. 5,614,319 (Wessels et al) describes an insulating composition for a conductor. A mixture of a polyolefin and a partially fluorinated copolymer as a mixture can be used as either a solid or foamed insulation over a metallic conductor in a plenum-type communications cable. The insulated wires can be used in the transmission of electronic signals, such as voice, data, or video.

10. While the above and other reports represent several techniques associated with the manufacture of polymeric coated wire or polymeric foam coated wire, there is a need in the industry for high-strength, simply-manufactured, inexpensive polymeric foam wire coatings. It is an object of the invention to produce such coatings.

### SUMMARY OF THE INVENTION

11. The present invention provides a series of techniques for extruding microcellular material onto communication elements, and articles including microcellular material in connection with communication elements. In one aspect the invention provides a series of methods, one being a technique that involves continuously extruding microcellular material onto a surface of a data communications element.

12. In another aspect the invention provides a system for producing microcellular polymeric material on a surface of a data communications element. The system includes an extruder having an inlet at an inlet end thereof designed to receive a precursor of microcellular material and an outlet at an outlet end thereof designed to release microcellular material. An enclosed passageway connects the inlet with the outlet and is constructed and arranged to contain a product of the mixture of a precursor of microcellular material and a blowing agent in a fluid state within the passageway and to advance the product as a fluid stream in a downstream direction from the inlet end toward the outlet end. A nucleating pathway is associated with the passageway and is capable of nucleating the product in the passageway. The extruder is adapted to receive a data communications element and to position the data communications element in communication with the passageway.

13. In another aspect the invention provides a series of articles. One article includes a data communications element, and a coating of microcellular material on a surface of the data communications element. The coating has a maximum thickness of less than about 0.5 mm.

14. Other advantages, novel features, and objects of the invention will become apparent from the following detailed description of the invention when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

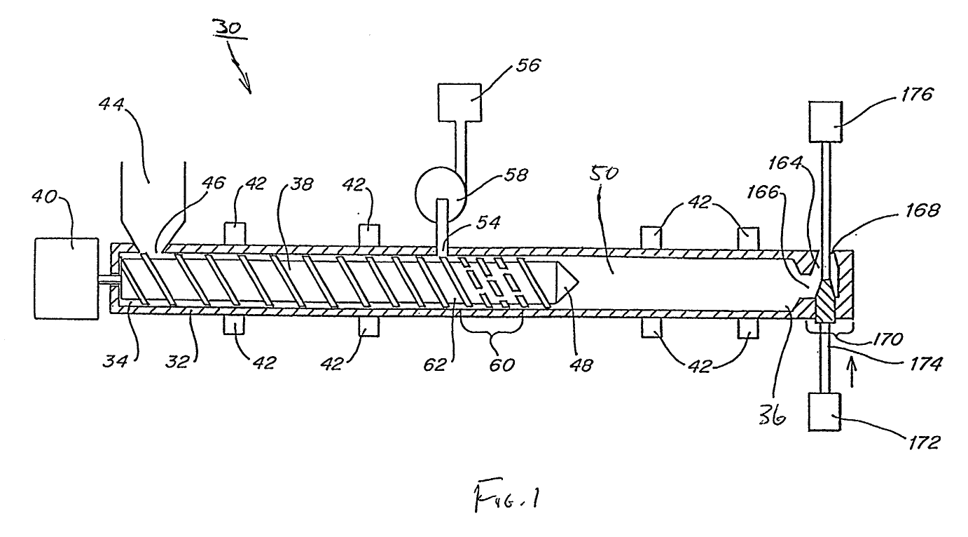

15. FIG. 1 illustrates a data communications extrusion system of the invention including a tapered nucleating pathway;

16. FIG. 2 illustrates a data communications element defining a wire including a single solid conductor and a surrounding coating of microcellular material;

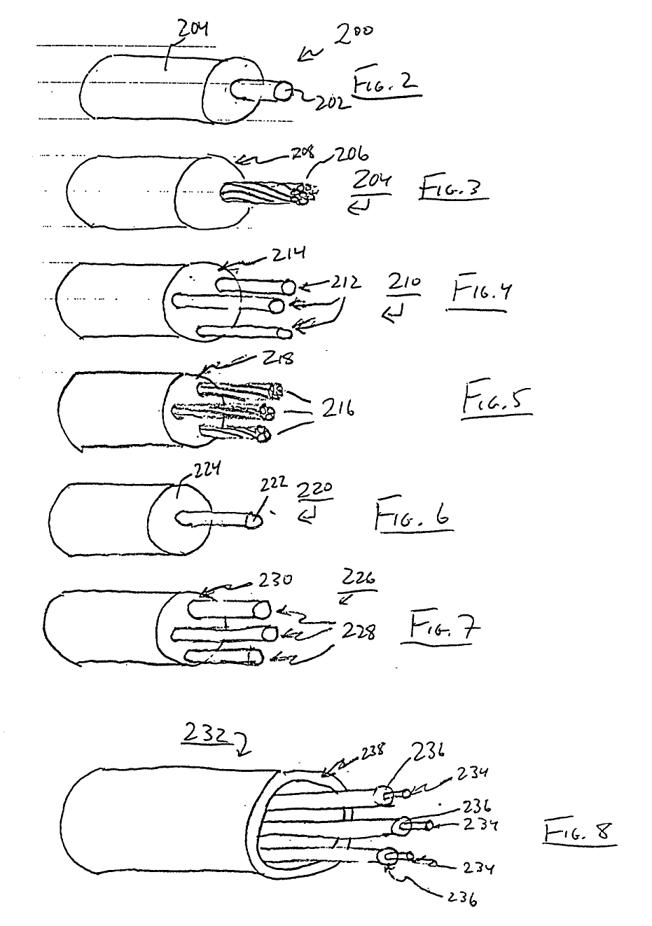

17. FIG. 3 illustrates a wire including a single braided conductor and a surrounding coating of microcellular material;

18. FIG. 4 illustrates a wire including multiple solid conductors and a region of microcellular material which surrounds, coats, and separates the conductors;

19. FIG. 5 illustrates a wire including multiple braided conductors and a region of microcellular material which surrounds, coats, and separates the conductors;

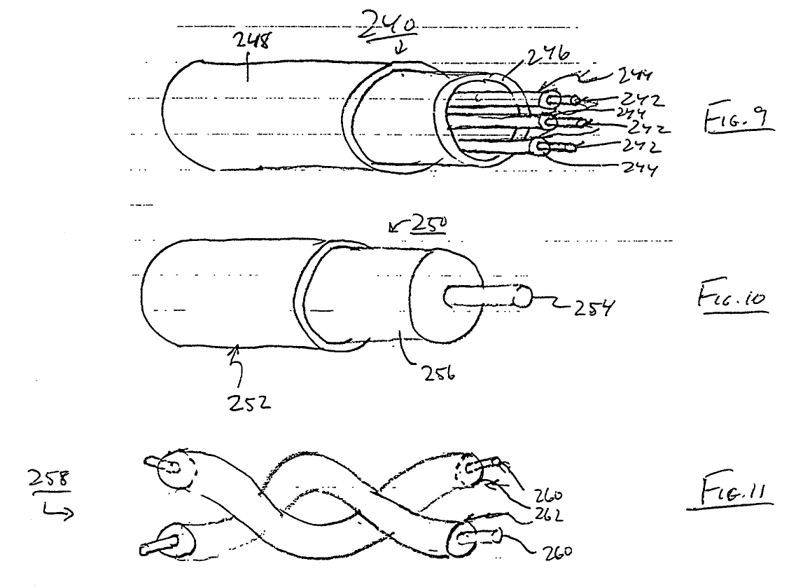

20. FIG. 6 illustrates a data communications article including a single optical fiber and a surrounding coating of microcellular material;

21. FIG. 7 illustrates multiple optical fibers and a region of microcellular material which surrounds, coats, and separates the optical fibers;

22. FIG. 8 illustrates an electrical cable including a plurality of conductors, each coated with a layer of microcellular material, and a tube of microcellular material that surrounds the conductors;

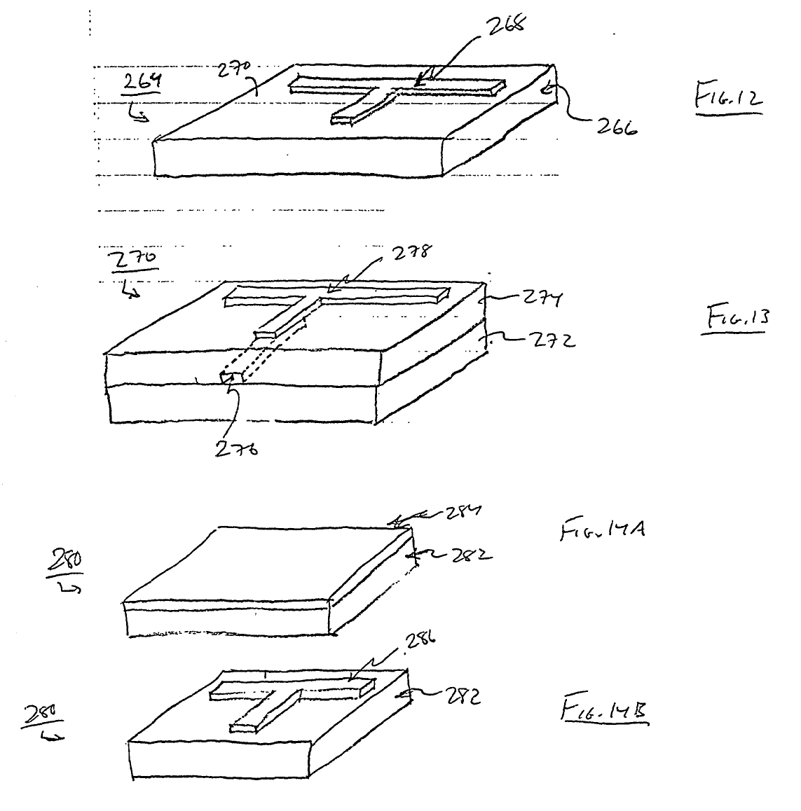

23. FIG. 9 illustrates an electrical cable including a plurality of conductors, each coated with a layer of microcellular material, and a metal tube, coated with a layer of microcellular material, that surrounds the conductors;

24. FIG. 10 illustrates a coaxial cable including an outer metal tube, an inner metal conductor, and microcellular material filling the region between the outer tube and the inner conductor;

25. FIG. 11 illustrates a twisted pair cable including two metal conductors, each coated with microcellular material, twisted about each other in a helical manner;

26. FIG. 12 illustrates a printed circuit board including a sheet of microcellular material and electrically conducting connectors deposited on a surface of the sheet;

27. FIG. 13 illustrates a multilevel circuit board with a plurality of sheets of microcellular material and a plurality of layers of electrically conducting connections;

28. FIG. 14A illustrates a printed circuit board a sheet of microcellular material coated with a layer of metal;

29. FIG. 14B illustrates the printed circuit board of FIG. 14A after etching, removing excess metal leaving electrically conducting connections;

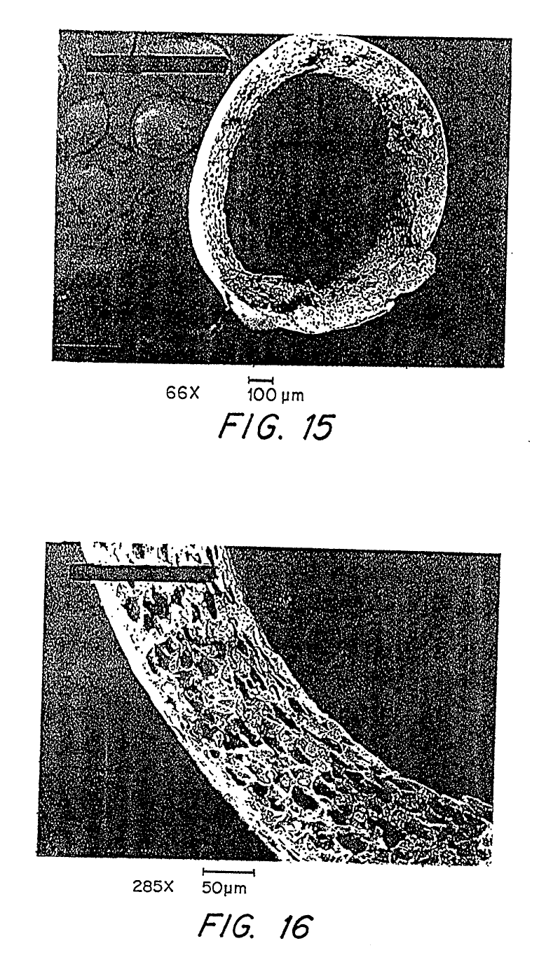

30. FIG. 15 is a photocopy of a scanning electron micrograph (SEM) image of a cross-section of microcellular polymeric material extrusion coated onto wire, following removal of the wire;

31. FIG. 16 is a photocopy of an SEM image of the coating of FIG. 15, at higher magnification;

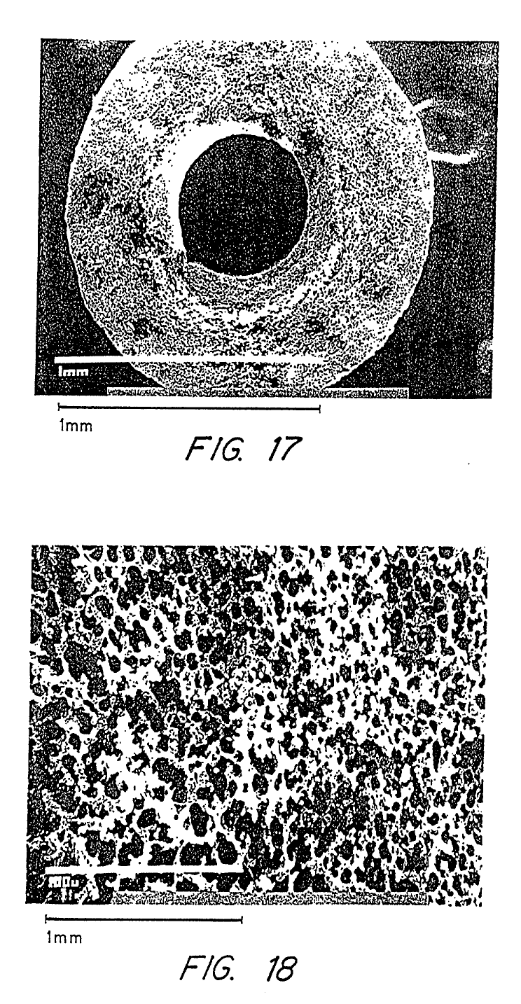

32. FIG. 17 is a photocopy of an SEM image of a cross-section of microcellular polymeric material extrusion coated onto wire, following removal of the wire;

33. FIG. 18 is a photocopy of an SEM image of the coating of FIG. 17, at higher magnification;

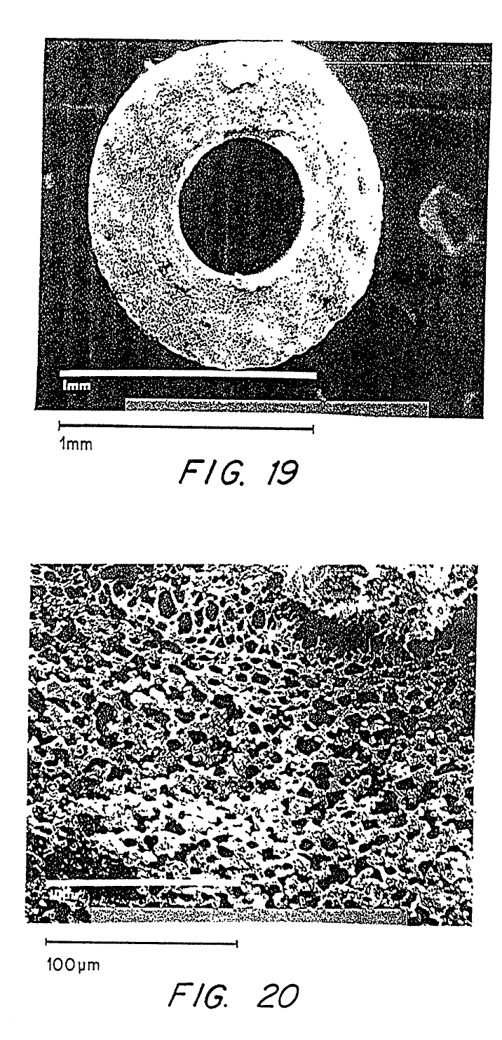

34. FIG. 19 is a photocopy of an SEM image of a cross-section of another example of microcellular wire coating;

35. FIG. 20 is a photocopy of an SEM image of the microcellular wire coating of FIG. 19 at higher magnification;

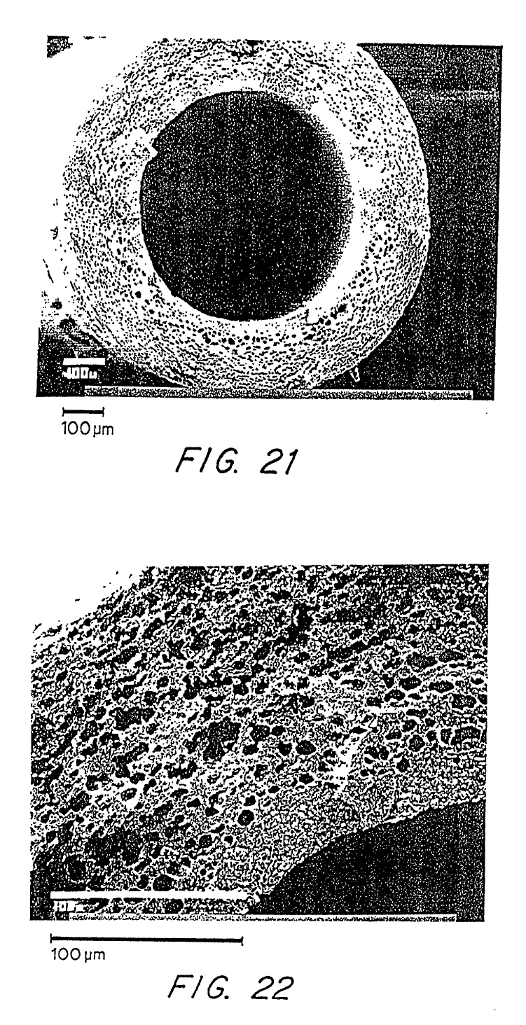

36. FIG. 21 is a photocopy of an SEM image of a cross-section of another example of microcellular wire coating;

37. FIG. 22 is a photocopy of an SEM image of the microcellular wire coating of FIG. 21 at higher magnification;

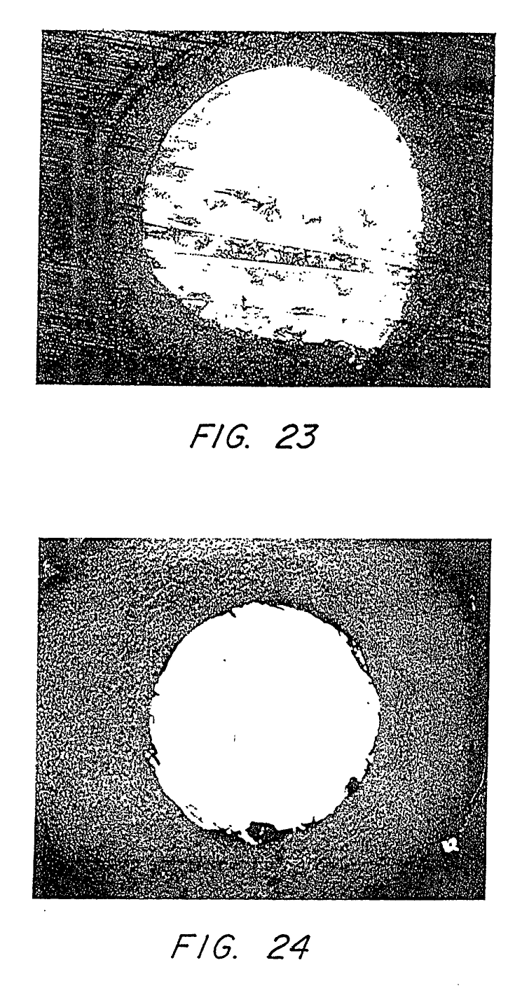

38. FIG. 23 is a photocopy of an optical micrograph of the wire coating sample of FIGS. 21 and 22, without wire removed, mounted in epoxy; and

39. FIG. 24 is a photocopy of an optical micrograph of the wire coating sample of FIGS. 21 and 22, without wire removed, mounted in epoxy.

### DETAILED DESCRIPTION OF THE INVENTION

40. Commonly-owned, co-pending U.S. patent application Ser. No. 08/777,709 “Method and Apparatus for Microcellular Polymer Extrusion”, filed Dec. 20, 1996 and commonly-owned, co-pending International patent application serial no. PCT/US97/15088, filed Aug. 26, 1997 are incorporated herein by reference.

41. The various embodiments and aspects of the invention will be better understood from the following definitions. As used herein, “nucleation” defines a process by which a homogeneous, single-phase solution of polymeric material, in which is dissolved molecules of a species that is a gas under ambient conditions, undergoes formations of clusters of molecules of the species that define “nucleation sites”, from which cells will grow. That is, “nucleation” means a change from a homogeneous, single-phase solution to a mixture in which sites of aggregation of at least several molecules of blowing agent are formed. Nucleation defines that transitory state when gas, in solution in a polymer melt, comes out of solution to form a suspension of bubbles within the polymer melt. Generally this transition state is forced to occur by changing the solubility of the polymer melt from a state of sufficient solubility to contain a certain quantity of gas in solution to a state of insufficient solubility to contain that same quantity of gas in solution. Nucleation can be effected by subjecting the homogeneous, single-phase solution to rapid thermodynamic instability, such as rapid temperature change, rapid pressure drop, or both. Rapid pressure drop can be created using a nucleating pathway, defined below. Rapid temperature change can be created using a heated portion of an extruder, a hot glycerin bath, or the like. A “nucleating agent” is a dispersed agent, such as talc or other filler particles, added to a polymer and able to promote formation of nucleation sites from a single-phase, homogeneous solution. Thus “nucleation sites” do not define locations, within a polymer, at which nucleating agent particles reside. “Nucleated” refers to a state of a fluid polymeric material that had contained a single-phase, homogeneous solution including a dissolved species that is a gas under ambient conditions, following an event (typically thermodynamic instability) leading to the formation of nucleation sites. “Non-nucleated” refers to a state defined by a homogeneous, single-phase solution of polymeric material and dissolved species that is a gas under ambient conditions, absent nucleation sites. A “non-nucleated” material can include nucleating agent such as talc. A “polymeric material/blowing agent mixture” can be a single-phase, non-nucleated solution of at least the two, a nucleated solution of at least the two, or a mixture in which blowing agent cells have grown. “Essentially closed-cell” microcellular material is meant to define material that, at a thickness of about 100 microns, contains no connected cell pathway through the material. “Nucleating pathway” is meant to define a pathway that forms part of microcellular polymeric foam extrusion apparatus and in which, under conditions in which the apparatus is designed to operate (typically at pressures of from about 1500 to about 30,000 psi upstream of the nucleator and at flow rates of greater than about 10 pounds polymeric material per hour), the pressure of a single-phase solution of polymeric material admixed with blowing agent in the system drops below the saturation pressure for the particular blowing agent concentration at a rate or rates facilitating rapid nucleation. A nucleating pathway defines, optionally with other nucleating pathways, a nucleation or nucleating region of a device of the invention. “Reinforcing agent”, as used herein, refers to auxiliary, essentially solid material constructed and arranged to add dimensional stability, or strength or toughness, to material. Such agents are typified by fibrous material as described in U.S. Pat. Nos. 4,643,940 and 4,426,470. “Reinforcing agent” does not, by definition, necessarily include filler or other additives that are not constructed and arranged to add dimensional stability. Those of ordinary skill in the art can test an additive to determine whether it is a reinforcing agent in connection with a particular material.

42. In preferred embodiments, foam material of the invention is microcellular material and has average cell size of less than about 50 microns. In some embodiments particularly small cell size is desired, and in these embodiments material of the invention has average cell size of less than about 30 microns, more preferably less than about 20 microns, more preferably less than about 10 microns, and more preferably still less than about 5 microns. The microcellular material preferably has a maximum cell size of about 100 microns or preferably less than about 75 microns. In embodiments where particularly small cell size is desired, the material can have maximum cell size of about 50 microns, more preferably about 35 microns, and more preferably still about 25 microns.

43. Foam material of the invention can have a void volume of at least about 5%, more preferably at least about 10%, more preferably at least about 15%, more preferably still at least about 20%, and more preferably still at least about 30% according to one set of embodiments. These sets of embodiments allow significant increase in dielectric constant adjacent the data communications substrates of the invention. In another set of embodiments the material has a void volume of at least about 50%, more preferably at least about 60%, more preferably at least about 70%, and more preferably still at least about 75%. Increasing cell density while maintaining essentially closed-cell, microcellular material where that material is desired can be achieved by using high pressure drop rates as described in international patent application serial no. PCT/US97/15088, referenced above. Void volume, in this context, means initial void volume, i.e., typically void volume immediately after extrusion and cooling to ambient conditions. That is, formation of foam material at a void volume of 50%, followed by compaction resulting in a void volume of 40%, is still embraced by the definition of material at 50% void volume in accordance with the invention.

44. A set of embodiments includes all combinations of average cell sizes, maximum cell sizes and void volumes noted above. For example, one embodiment in this set of embodiments includes microcellular material having an average cell size of less than about 30 microns with a maximum cell size of about 50 microns and void volume of at least about 20%, and as another example an average cell size of less than about 30 microns with a maximum cell size of about 35 microns and void volume of at least about 30% is provided, etc. That is, microcellular material designed for a variety of purposes can be produced having a particular combination of parameters preferable for that purpose.

45. Specifications for wire for high level data communication require that the electrical insulation withstand a substantial crushing force. Such a force results from the construction of some types of cables, such as twisted pair, and from the installation process where the wire will be subjected to potentially damaging forces during that installation.

46. The invention resides in the surprising discovery of unexpected strength associated with thin polymeric microcellular coating on data communications elements. In particular, polymeric microcellular wire coating of the invention passes UL 444 Section 6.2 Crush Resistance Test necessary for Category 5 data communications cable. Microcellular-coated wire passes this test even in the absence of a solid exterior coating normally thought necessary for polymeric foam coatings on wire to have sufficient strength to be used in crush-resistant applications. That is, unlike other types of insulating foam materials, microcellular material does not require an external sheath of plastic to pass the crush test required for Category 5 data communication cable. This permits simpler and more economical wire manufacture. Accordingly, in preferred embodiments, the microcellular polymeric wire coating of the invention is free of any exterior solid polymeric coating that completely coats and envelopes the exterior surface of the microcellular polymeric wire coating and has a thickness of greater than about 500 nm. More preferably, the coating is free of any exterior, enveloping solid polymeric layer of greater than about 250 nm, preferably free of such a layer greater than 100 nm, more preferably still greater than such a layer of greater than 50 nm.

47. In another set of embodiments, a microcellular polymeric coating on wire is provided that passes the above-mentioned crush test and is formed of a first polymeric material, the coating being free of any exterior coating of a second polymeric material that is different in chemical composition than the first polymeric material. That is, the polymeric coating of the present invention exhibits strength without the need for a strength-supporting, solid exterior polymeric coating defined by a different polymeric material.

48. Preferably, the microcellular polymeric wire coating of the invention also is free of any interior solid polymeric layer. That is, the articles of the invention are free of a solid polymeric layer between the exterior surface of the wire and the interior surface of the microcellular polymeric wire coating of a thickness greater than 500 nm, or more preferably other, reduced thicknesses as described above. In another embodiment other articles of the invention are free of any material between the exterior surface of the wire and interior surface of the polymeric microcellular coating that is of a composition different from that of the polymeric microcellular coating. These embodiment represent the unexpected advantage of strength, as described above, without a so-called “skin-foam-skin”, “skin-foam”, or “foam-skin” arrangement. Many prior art arrangements compel the assumption among those of ordinary skill in the art that such arrangements, especially a foam-skin arrangement (foam coating on wire with an exterior, solid layer to add strength) would be required to pass the above-noted strength test. These embodiments also represent the unexpected advantage of good adhesion of the polymeric microcellular coating to wire in the absence of any auxiliary adhesive or the like.

49. In one aspect, the present invention provides systems for extrusion of microcellular material onto data communications elements, and such elements that include microcellular material on at least one surface thereof. As used herein, “data communications elements” includes those solid articles known to those of ordinary skill in the art to be suitable for high-speed communication of data, such as electrical conductors, optical fibers, and other such elements that ideally include a very high dielectric constant material surrounding them. The present invention provides methods for producing electrical and optical connectors in the form of wires, cables, and printed circuit boards using microcellular material to provide electrical insulation and optical isolation. Use of microcellular material according to the invention extends the range of communication applications otherwise possible with foam polymer material. The vacancies or voids in microcellular material reduce the effective dielectric constant of the material below that of its polymer precursor, while providing sufficient strength to the material to permit electronic devices connected by conductors clad with microcellular material to exchange data at a faster rate. Optical devices also benefit from a coating of microcellular material, that is, a cladding of a lower effective dielectric constant (hence refractive index material), as provided by the invention. A reduced index of refraction aids in confining optical beams to optical fibers. Where multiple optical fibers are used, microcellular material reduces the crosstalk between the optical fibers. Fiber optic conductors coated with microcellular material also can be less susceptible to fractures than similar conductors having solid or non-microcellular insulating material.

50. Where data communication cables are used, microcellular material can reduce the time delay associated with such cables. Where sheets of microcellular material are used with electronic devices, these sheets can bring the benefits of reduced communication delays to electronic chips mounted on printed circuit boards.

51. The present invention describes methods of producing several forms of electrical connection. These include single and multiconductor wire, twisted pair cable, coaxial cable, and multiwire cable sheathed with metal or multicellular material, and the like. The microcellular material can also be made in sheet form, and, as such, can function as the base of printed circuit boards. Both direct deposition and etching can delineate the electrical connections. In some embodiments, several microcellular printed circuit boards can be assembled together to form multilayer structures capable of interconnecting many complex semiconductor chips, each of which contains large numbers of pins.

52. The aspect of the invention that provides a system for extruding microcellular material onto wire is advantageous for the following reasons. As mentioned, foam material is advantageous relative to solid material for wire insulation because foamed material provides enhanced electrical properties with increased void fraction (less material per unit volume). However, in any foaming technique, if the thickness of the material formed is less than the maximum cell size, holes will exist in the material. This is unacceptable in typical wire coating applications since holes would allow moisture ingress and compromise electrical performance. Physical properties of such material would also be compromised. In the very thin insulation wall thicknesses of Category 5 and similar wires it has been difficult or impossible to form foamed insulation on wire.

53. Uniformity of cell structure is important in this arrangement for uniform capacitance, high velocity of propagation resulting from low dielectric constant, good mechanical strength, and low water absorbance. Compared to a solid material, a foamed material with similar characteristics will provide relatively less combustible mass and hence byproducts of combustion, making microcellular foam coated wires less hazardous under high-temperature or other ignition conditions.

54. FIG. 1 illustrates schematically an extrusion system 30 for extruding microcellular material onto wire. System 30 includes a barrel 32 having a first, upstream end 34 and a second, downstream end 36. Mounted for rotation within barrel 32 is an extrusion screw 38 operably connected, at its upstream end, to a drive motor 40. Although not shown in detail, extrusion screw 38 includes feed, transition, gas injection, mixing, and metering sections.

55. Positioned along extrusion barrel 32, optionally, are temperature control units 42. Control units 42 can be electrical heaters, can include passageways for temperature control fluid, or the like. Units 42 can be used to heat a stream of pelletized or fluid polymeric material within the extrusion barrel to facilitate melting, and/or to cool the stream to control viscosity, skin formation and, in some cases, blowing agent solubility. The temperature control units can operate differently at different locations along the barrel, that is, to heat at one or more locations, and to cool at one or more different locations. Any number of temperature control units can be provided.

56. Extrusion barrel 32 is constructed and arranged to receive a precursor of microcellular material. Typically, this involves a standard hopper 44 for containing pelletized polymeric material to be fed into the extruder barrel through orifice 46. Although preferred embodiments do not use chemical blowing agents, when chemical blowing agents are used they typically are compounded in polymer pellets introduced into hopper 44.

57. Immediately downstream of the downstream end 48 of screw 38 in FIG. 1 is a region 50 which can be a temperature adjustment and control region, auxiliary mixing region, auxiliary pumping region, or the like. For example, region 50 can include temperature control units to adjust the temperature of a fluid polymeric stream prior to nucleation, as described below. Region 50 can include instead, or in addition, standard mixing units (not shown), or a flow-control unit such as a gear pump (not shown). In another embodiment, region 50 is replaced by a second screw of a tandem extrusion apparatus, the second screw optionally including a cooling region.

58. Any of a wide variety of blowing agents can be used in connection with the present invention. Preferably, a physical blowing agent (a blowing agent that is a gas under ambient conditions) or mixture of physical blowing agents is used and, in this case, along barrel 32 of system 30 is a port 54 in fluid communication with a source 56 of a physical blowing agent. Physical blowing agents known to those of ordinary skill in the art such as hydrocarbons, chlorofluorocarbons, nitrogen, carbon dioxide, and the like can be used in connection with this embodiment of the invention and, according to a preferred embodiment, source 56 provides an atmospheric blowing agent, most preferably carbon dioxide. A pressure and metering device 58 typically is provided between blowing agent source 56 and port 54. Supercritical fluid blowing agents are especially preferred, in particular supercritical carbon dioxide. In one embodiment, blowing agent is introduced into the extruder below supercritical conditions and conditions within the extruder are set above supercritical blowing agent conditions. In another embodiment, supercritical blowing agent is delivered through port 54 into the extruder, and conditions within the extruder are maintained above super critical blowing agent conditions. While physical blowing agents are preferred, chemical blowing agents can be used. Suitable chemical blowing agents include those typically relatively low molecular weight organic compounds that decompose at a critical temperature or another condition achievable in extrusion and release a gas or gases such as nitrogen, carbon dioxide, or carbon monoxide. Examples include azo compounds such as azo dicarbonamide. Where a chemical blowing agent is used, the blowing agents can be introduced into systems of a invention by being compounded within polymer pellets fed into the system, or other techniques available to those of ordinary skill in the art.

59. In preferred embodiments of the invention, the techniques of the invention do not require the added expense and complication of formulating a polymeric precursor to include a species that will react under extrusion conditions to form a blowing agent. Since foams blown with chemical blowing agents inherently include residual, unreacted chemical blowing agent after a final foam product has been produced, as well as chemical by-products of the reaction that forms a blowing agent, microcellular material of the present invention in this set of embodiments includes residual chemical blowing agent or reaction by-product of chemical blowing agent, in an amount less than that inherently found in articles blown with 0.1% by weight chemical blowing agent or more, preferably including residual chemical blowing agent or reaction by-product of chemical blowing agent in an amount less than that inherently found in articles blown with 0.05% by weight chemical blowing agent or more. In particularly preferred embodiments, the material is characterized by being essentially free of residual chemical blowing agent or free of reaction by-products of chemical blowing agent. That is, they include less residual chemical blowing agent or by-product than is inherently found in articles blown with any chemical blowing agent, which residual by-products can adversely effect electrical performance.

60. One advantage of embodiments in which a chemical blowing agent is not used or used in minute quantities is that recyclability of product is maximized. Use of a chemical blowing agent typically reduces the attractiveness of a polymer to recycling since residual chemical blowing agent and blowing agent by-products contribute to an overall non-uniform recyclable material pool.

61. Device 58 can be used to meter the blowing agent so as to control the amount of the blowing agent in the polymeric stream within the extruder to maintain a level of blowing agent at a level, according to one set of embodiments, between about 1% and 15% by weight based on the weight of the polymer, preferably between about 3% and 12% by weight, more preferably between about 5% and 10% by weight, more preferably still between about 7% and 9% by weight, based on the weight of the polymeric stream and blowing agent. In other embodiments it is preferred that lower levels of blowing agent be used. For example, blowing agent in an amounts less than about 1.5% by weight or less than about 1% by weight can be used in certain circumstances (see examples 3-6). As described in PCT/US97/15088, referenced above, different levels of blowing agent are desirable under different conditions and/or for different purposes which can be selected in accordance with the invention.

62. The pressure and metering device can be connected to a controller (not shown) that also is connected to drive motor 40 and/or a drive mechanism of a gear pump (not shown) to control metering of blowing agent in relationship to flow of polymeric material to very precisely control the weight percent blowing agent in the fluid polymeric mixture.

63. Although port 54 can be located at any of a variety of locations along the extruder barrel, according to a preferred embodiment it is located just upstream from a mixing section 60 of the extrusion screw and at a location 62 of the screw where the screw includes unbroken flights.

64. In a preferred embodiment of the blowing agent port system, two ports on opposing top and bottom sides of the barrel are provided. In this preferred embodiment, port 54 is located at a region upstream from mixing section of screw 38 (including highly-broken flights) at a distance upstream of the mixing section of no more than about 4 full flights, preferably no more than about 2 full flights, or no more than 1 full flight. Positioned as such, injected blowing agent is very rapidly and evenly mixed into a fluid polymeric stream to quickly produce a single-phase solution of the foamed material precursor and the blowing agent.

65. Port 54, in the preferred embodiment is a multi-hole port including a plurality of orifices connecting the blowing agent source with the extruder barrel. In preferred embodiments a plurality of ports 54 are provided about the extruder barrel at various positions radially and can be in alignment longitudinally with each other. For example, a plurality of ports 54 can be placed at the 12 o'clock, 3 o'clock, 6 o'clock, and 9 o'clock positions about the extruder barrel, each including multiple orifices. In this manner, where each orifice is considered a blowing agent orifice, the invention includes extrusion apparatus having at least about 10, preferably at least about 40, more preferably at least about 100, more preferably at least about 300, more preferably at least about 500, and more preferably still at least about 700 blowing agent orifices in fluid communication with the extruder barrel, fluidly connecting the barrel with a source of blowing agent.

66. Also in preferred embodiments is an arrangement in which the blowing agent orifice or orifices are positioned along the extruder barrel at a location where, when a preferred screw is mounted in the barrel, the orifice or orifices are adjacent full, unbroken flights. In this manner, as the screw rotates, each flight, passes, or “wipes” each orifice periodically. This wiping increases rapid mixing of blowing agent and fluid foamed material precursor by, in one embodiment, essentially rapidly opening and closing each orifice by periodically blocking each orifice, when the flight is large enough relative to the orifice to completely block the orifice when in alignment therewith. The result is a distribution of relatively finely-divided, isolated regions of blowing agent in the fluid polymeric material immediately upon injection and prior to any mixing. In this arrangement, at a standard screw revolution speed of about 30 rpm, each orifice is passed by a flight at a rate of at least about 0.5 passes per second, more preferably at least about 1 pass per second, more preferably at least about 1.5 passes per second, and more preferably still at least about 2 passes per second. In preferred embodiments, orifices are positioned at a distance of from about 15 to about 30 barrel diameters from the beginning of the screw (at upstream end 34).

67. The described arrangement facilitates a method of the invention that is practiced according to one set of embodiments. The method involves introducing, into fluid polymeric material flowing at a rate of at least about 20 lbs/hr. or about 40 lbs/hr., a blowing agent that is a gas under ambient conditions and, in a period of less than about 1 minute, creating a single-phase solution of the blowing agent fluid in the polymer. The blowing agent fluid is present in the solution in an amount of at least about 2.5% by weight based on the weight of the solution in this arrangement. In preferred embodiments, the rate of flow of the fluid polymeric material is at least about 60 lbs/hr., more preferably at least about 80 lbs/hr., and in a particularly preferred embodiment greater than at least about 100 lbs/hr., and the blowing agent fluid is added and a single-phase solution formed within one minute with blowing agent present in the solution in an amount of at least about 3% by weight, more preferably at least about 5% by weight, more preferably at least about 7%, and more preferably still at least about 10% (although, as mentioned, in a another set of preferred embodiments lower levels of blowing agent are used). In these arrangements, at least about 2.4 lbs per hour blowing agent, preferably CO₂, is introduced into the fluid stream and admixed therein to form a single-phase solution. The rate of introduction of blowing agent is matched with the rate of flow of polymer to achieve the optimum blowing agent concentration.

68. System 30 includes a constriction 164 at the downstream end of the barrel that is a nucleating pathway having an entrance 166 and an exit 168, and the nucleating pathway 164 decreases in cross-sectional area in a downstream direction. Nucleating pathway 164 communicates with a crosshead die 170 arranged to receive a product of the mixture of a precursor of microcellular material and blowing agent and to nucleate the material and to apply microcellular material to the data communications element. This can involve die 170 arranged to receive extruded, nucleated microcellular material from exit 168 of nucleating pathway 164 and to apply the material to the exterior surface of a data communications element and allow the material to foam into microcellular material, or to receive a homogeneous single-phase solution of blowing agent and precursor and to apply the solution to the surface of the data communications element while nucleating the solution and then allowing the nucleated material to experience cell growth to form microcellular material on the element. A payoff 172 is positioned to feed data communications element 174 such as wire into the crosshead 170. A take-up arrangement 176 is positioned to receive data communications element 174 coated with microcellular material from the crosshead. Payoffs and take-ups for wire are known, and standard arrangements can be used in the invention. Although not shown, the system can include components such as data communications element preheaters, a cooling trough between the crosshead and take-up, and sensors such as capacitance sensors and thickness sensors arranged to sense dimensional and electrical characteristics of the coated data communications element.

69. Although a pressure type die is illustrated, a tube-type tooling design can be used in the invention. A pressure type design is a die and tip design in which the data communications element is exposed to polymer flow behind the die. A tube type design is one in which the data communications element is not exposed to polymer until the element exits from the die.

70. A single or tandem extruder, as described, can be adapted to carry out all of the techniques of the invention, including wire coating. An arrangement can be adapted for wire coating by the addition of a crosshead die assembly, where the assembly is defined as an adapter, transfer tube, and wire handling system comprised of a payoff, wire straightener, preheater, cooling trough, puller, and winder.

71. The aspect of the invention that provides a system for extruding microcellular material onto a data communications element such as wire is advantageous for the following reasons. Foam material is advantageous relative to solid material for wire insulation because foamed material provides enhanced electrical properties with increased void fraction (less material per unit volume). However, in any foaming technique, if the thickness of the material formed is less than the maximum cell size, holes will exist in the material. This is unacceptable in typical wire coating applications since holes would allow moisture ingress and compromise electrical performance. Physical properties of such material would also be compromised. In the very thin insulation wall thicknesses of Category 5 and similar wires it has been difficult or impossible to form foamed insulation on wire.

72. The present invention provides an arrangement in which microcells can be created in a manner in which the cellular structure is a relatively hermetic barrier to moisture as well as providing the required physical properties appropriate for category 5 applications. In particular, the microcellular material coating of the invention has a moisture absorption of less than 0.1% by weight based on the weight of the coating after immersion in water for 24 hours. In preferred embodiments, the microcellular material has a moisture absorption of less than 0.25% by weight after immersion in water for 24 hours. Also, the coating of the invention has a moisture absorption of essentially zero after exposure to 100% relative humidity conditions for 24 hours.

73. Uniformity of cell structure is important in this arrangement for uniform capacitance, high velocity of propagation resulting from low dielectric constant, good mechanical strength, and low water absorbance. Compared to a solid material, a foamed material with similar characteristics will provide relatively less combustible mass and hence byproducts of combustion, making microcellular foam coated wires less hazardous.

74. In connection with formation of microcellular coatings on wires, particularly thin microcellular material is produced. According to this aspect of the invention, microcellular material, preferably essentially closed-cell material, of thickness less than about 4 mm, preferably less than about 3 mm, more preferably less than about 1 mm is produced. In some embodiments extremely thin microcellular material is produced, namely material of less than about 0.5 mm in thickness, more preferably less than about 0.25 mm in thickness, more preferably still less than about 0.2 mm in thickness. In some particularly preferred embodiments material on the order of 0.1 mm in thickness is produced. All of these embodiments can include essentially closed-cell material, and offer the advantages of crush-resistance and hermetic sealing (moisture impermeability) described above.

75. The arrangement of the invention allows for injecting blowing agent and maintaining the fluid stream, downstream of injection and upstream of nucleation, under pressure varying by no more than 1000 psi, preferably no more than about 750 psi, and more preferably still no more than about 500 psi.

76. The fluid pathway of the nucleator has length and cross-sectional dimensions that subject the single-phase solution, as a flowing stream, to conditions of solubility change sufficient to create sites of nucleation at the microcellular scale in the absence of auxiliary nucleating agent. “At the microcellular scale” defines a cell density that, with controlled foaming, can lead to microcellular material. While nucleating agent can be used in some embodiments, in other embodiments no new nucleating agent is used. In either case, the pathway is constructed so as to be able to create sites of nucleation in the absence of nucleating agent whether or not nucleating agent is present. In particular, the fluid pathway has dimensions creating a desired pressure drop rate through the pathway. In one set of embodiments, the pressure drop rate is relatively high, and a wide range of pressure drop rates are achievable. A pressure drop rate can be created, through the pathway, of at least about 0.1 GPa/sec in molten polymeric material admixed homogeneously with about 6 wt % CO₂ passing through the pathway of a rate of about 40 pounds fluid per hour. Preferably, the dimensions create a pressure drop rate through the pathway of from about 0.2 GPa/sec to about 1.5 GPa/sec, or from about 0.2 GPa/sec to about 1 GPa/sec. The nucleator is constructed and arranged to subject the flowing stream to a pressure drop at a rate sufficient to create sites of nucleation at a density of at least about 10⁷ sites/cm³. preferably at least about 10⁸ sites/cm³. In other embodiments, the dimensions create a pressure drop rate through the pathway of at least about 0.3 GPa/sec under these conditions, more preferably at least about 1 GPa/sec, more preferably at least about 3 GPa/sec, more preferably at least about 5 GPa/sec, and more preferably still at least about 7, 10, or 15 Gpa/sec.

77. The arrangement of FIG. 1 is constructed and arranged to continuously nucleate a fluid stream of single-phase solution of polymeric material and flowing agent flowing at a rate of at least 10 lbs/hour, preferably at least about 20 lbs/hour, more preferably at least about 50 lbs/hour, more preferably at least about 70 lbs/hour, and more preferably still at least about 100 lbs/hour. In FIG. 1 nucleation takes place significantly upstream of shaping. One aspect of the invention involves production of microcellular foam crystalline and semi-crystalline polymeric material coating on data communication elements, formed by continuous extrusion. In preferred embodiments crystalline and semi-crystalline polymeric material is foamed as microcellular material with a blowing agent that is essentially solely carbon dioxide, preferably supercritical carbon dioxide. As noted above, the prior art generally teaches that the expansion of nucleation sites, or cell growth, may be minimized by, for example, cooling the melt prior to extrusion or by quenching the material upon exposure to atmosphere in order to freeze cell growth. Alternatively, the prior art teaches that such expansion may be controlled by the use of viscosity modifiers or foam-controllability additives. Such additives increase the controllability of foaming by generally functioning to increase melt strength and/or melt elasticity. Crystalline and semi-crystalline materials require much higher operating temperatures than amorphous materials, as it is necessary to operate at the Tm or above in order to prevent crystallization of such materials in, for example, an extruder. Such conditions are contrary to the prior art, which teaches that with regard to the production of amorphous microcellular material such as, for example, polystyrene, it is necessary to minimize the difference between the Tg and the extrusion temperature of an amorphous polymer in order to prevent expansion of cells beyond the microcellular range.

78. In general, the difference between the required operating temperature and the Tg of crystalline and semi-crystalline materials is much greater than for amorphous polymers, as shown by a comparison of such values in Table A. For example, the difference between the Tg and a typical operating temperature for extruding polystyrene is about 40° C., whereas for LDPE it is about 135° C., and for PET it is about 155° C. In the table, Tg and Tm refer to values of polymeric material free of blowing agent. While not wishing to be bound by any theory, it is likely that operating temperature can be slightly below Tm because of viscosity modification by the blowing agent.

TABLE A*

| | | | | Operating | |
|---|---|---|---|---|---|
| | Material | Tg | Tm | Temperature | Delta |
| Material | Type | (° C.) | (° C.) | (° C.) | (° C.) |
| Polystyrene | Amorphous | 90-100 | n/a | 140 | 40-50 |
| Low Density | semi-crystalline | −110 | 115 | 110 | 220 |
| Polyethylene | | | | | |
| High Density | semi-crystalline | −110 | 134 | 145 | 255 |
| Polyethylene | | | | | |
| Polypropylene | semi-crystalline | −10 | 165 | 180 | 190 |
| Polyethylene | semi-crystalline | 70 | 260 | 230 | 160 |
| Terephthalate | | | | | |
| Nylon 6-6 | semi-crystalline | 50 | 240 | | |

*Tg and Tm from “Principals of Polymer Processing”, Tadmore, Z., Gogos, C., John Wiley & Sons, New York, 1979, p. 38.

79. Surprisingly, crystalline and semi-crystalline microcellular materials can be produced according to the present invention on the surfaces of data communication elements without the need to cool the melt to temperatures near the Tg, and without the use of viscosity or foam-controllability modifiers, as taught in the prior art. The present invention involves the discovery that well-controlled extrusion of microcellular material may be achieved, even at temperatures well above the Tg of a polymer, by operating at particularly high pressure drop rates. Such high pressure drop rates facilitate the continuous formation of crystalline and semi-crystalline microcellular materials. Although not wishing to be bound by any theory, it is believed that a reduction in the internal force associated with each nucleation site may be achieved by reducing the size of the nucleation sites and maintaining very small cells during foaming. This can be achieved, in turn, by creating many sites of nucleation. Under comparable processing conditions, a nucleated solution having more numerous, and smaller, nucleation sites will produce relatively smaller cells, since blowing agent distributed among more numerous cells results in less blowing agent per cell, therefore smaller cells during growth. Further, since the expansion force acting on an interior wall of a gaseous cell at a constant pressure increases with the square of the cell diameter, a smaller cell experiences much less expansion force per unit area of cell wall than does a larger cell. Smaller sites contain less entrained gas, and therefore have a lower internal pressure than larger sites. A reduction in the internal pressure results in reduced cell expansion.

80. It is theorized that the prior art teaching of cooling the melt for the purpose of increasing melt strength also achieves such a reduction in the expansion force by reducing the energy associated with the molecules of gas contained in each nucleation site. The reduced energy associated with the gas entrained therein results in a reduction in the internal pressure and reduced cell expansion upon extrusion to atmosphere.

81. Semicrystalline and crystalline microcellular materials that can be processed according to the method include polyolefins such as polyethylene and polypropylene, crosslinkable polyolefins, polyesters such as PET, polyamides such as Nylons, etc., and copolymers of these that are crystalline. In particular, unmodified standard production grade material can be used in contrast to standard prior art materials which, it typically has been taught, require modifications such as incorporation of foam-controllability additives including components of other polymer families (e.g. polycarbonate in polyethylene terephthalate) (see, for example, Boone, G. (Eastman Chemical Co.), “Expanded Polyesters for Food Packaging”, Conference Proceedings of Foam Conference, Sep. 10-12, 1996, Somerset, N.J.). These additives increase the controllability of foaming by generally functioning to increase melt strength and/or melt elasticity. In this aspect, microcellular material can be made having preferred average cell sizes, maximum cell sizes, and cell densities as described above, and can be processed according to techniques and systems described herein. Examples of material that do not include foam- controllability modifiers include Eastman 9663 PET and Wellman 61802 PET. According to the method, semicrystalline or crystalline microcellular material may be made having preferred average cell sizes, maximum cell sizes, and cell densities as described below.

82. Production of such crystalline or semi-crystalline material is facilitated by a method of the invention that involves melting the material and maintaining its temperature at least above the recrystallization temperature of the material. Preferably, a flowing fluid polymeric material is established by elevating the temperature of the material to at least the approximately Tm of the polymer or higher, and then extruding the material into ambient conditions while foaming and shaping the material into an extrudate shape at a die temperature at least about 100° F. (at least about 37.8° C.) above Tg, preferably at least about 120° F. (at least about 48.9° C.), more preferably at least about 150° F. (at least about 65.6° C.) above Tg of the crystalline or semi-crystalline polymer. In some embodiments foaming and shaping occurs at a die temperature even higher relative to Tg, for example at least about 200° F. (at least about 93.3° C.) above Tg, at least about 250° F. (at least about 121° C.), or at least about 300° F. (at least about 149° C.) above Tg. In this context, Tg and Tm refer to values of the polymer without addition of blowing agent.

83. This aspect of the invention facilitates a method of continuously extruding crystalline or semi-crystalline material from an extruder at a throughput rate of at least about 10 lbs/hr, preferably at least about 25 lbs/hr, more preferably at least about 40 lbs/hr, and in particularly high throughput rates at least 60, 80, or 100 lbs/hr. These high throughput rates are representative of a surprisingly advantageous result achieved not only with crystalline and semi-crystalline materials, but with other materials in the invention described herein.

84. Another aspect of the invention involves continuous extrusion of microcellular polymeric material onto data communication elements including filler in minimum amounts. Addition of filler is expected to have an effect opposite that of addition of flow-control modifiers, that is, to weaken melt strength. Using high pressure drop rates of the invention, microcellular material, including crystalline and semicrystalline material, having filler in an amount of at least about 10% by weight based on the weight of the entire mixture, or at least about 25%, or at least about 35%, or at least about 50% can be achieved. “Filler”, as used herein, includes those fillers known to those skilled in the art to be present in, for example, filled polyolefin. Typical fillers include talc, flame retardant, etc.

85. In the working examples below, nucleation takes place very closely upstream of final release and shaping. Any arrangement can serve as a nucleator that subjects a flowing stream of a single-phase solution of foamed material precursor and blowing agent to a solubility change sufficient to nucleate the blowing agent. This solubility change can involve a rapid temperature change, a rapid pressure change, for example caused by forcing material through an orifice where the rapid pressure drop takes place due to friction between the material and the orifice wall, or a combination, and those of ordinary skill in the art will recognize a variety of arrangements for achieving nucleation in this manner. A rapid pressure drop to cause nucleation is preferred. Where a rapid temperature change is selected to achieve nucleation, temperature control units can be provided about nucleator 66. Nucleation by temperature control is described in U.S. Pat. No. 5,158,986 (Cha., et al.) incorporated herein by reference. Temperature control units can be used alone or in combination with a fluid pathway of nucleator 66 creating a high pressure drop rate in fluid polymeric material flowing therethrough.

86. In accordance with each of these sets of preferred embodiments, the polymeric microcellular material coating the data communication elements of the invention is preferably at least about 80% free of cross-linking, more preferably at least about 90% free of cross-linking, or more preferably still essentially entirely free of cross-linking.

87. Sufficient strength of microcellular coatings and jackets of the invention sufficient to pass strength tests is achieved without necessity of reinforcing agents. Preferably, the articles of the invention have less than about 10% reinforcing agent by weight, more preferably less than about 5% reinforcing agent, more preferably still less than about 2% reinforcing agent, and in particularly preferred embodiments the articles of the invention are essentially free of reinforcing agent. “Reinforcing agent”, as used herein, refers to auxiliary, essentially solid material constructed and arranged to add dimensional stability, or strength or toughness, to material. Such agents are typified by fibrous material as described in U.S. Pat. Nos. 4,643,940 and 4,426,470. “Reinforcing agent” does not, by definition, include filler, colorant, or other additives that are not constructed and arranged to add dimensional stability. Since reinforcing agents are added to increase dimensional stability, they typically are rod-like in shape or otherwise shaped to have a ratio, of a maximum dimension to a minimum dimension (length to diameter in the case of a rod or fiber) of at least about 3, preferably at least about 5, more preferably at least about 10.

88. The arrangement of FIG. 1 can be adapted for continuous production of a variety of articles by varying the thickness, void fraction, and type of polymeric microcellular material extruded, and by varying the type of wire, braided wire, optical fibers, or other data communication elements fed through the crosshead.

89. Alternatively, multiple wires, braided wire, or optical fibers can be fed through a crosshead and can be kept spaced from each other to form articles as illustrated in FIGS. 4, 5, and 7, described more fully below. In other arrangements, a polymer extrusion apparatus that extrudes a tubular article, but without a centrally-fed wire or the like can be used to extrude a microcellular polymeric jacket for envelopment of multiple wires, and the like as described more fully below.

90. Several articles that represent different embodiments of the present invention now will be illustrated schematically. FIG. 2 illustrates a conductor arrangement 200 including a single solid wire 202 and a surrounding coating 204 of microcellular material.

91. FIG. 3 illustrates schematically a conductor arrangement 204 including a single braided conductor 206 and a surrounding coating of microcellular material 208.

92. FIG. 4 illustrates schematically a conductor arrangement 210 including multiple solid conductors 212 and a region of microcellular material 214 that surrounds, coats, and separates the conductors 212. Conductor 210 can be fabricated using the system of FIG. 1 by feeding multiple wires through the wire extruder.

93. FIG. 5 illustrates schematically a system similar to that of FIG. 4, including multiple braided conductors 216 and a region of microcellular material 218 that surrounds, coats, and separates the braided conductors.

94. FIGS. 6 and 7 illustrate schematically optical devices of the present invention. FIG. 6 shows a coated optical fiber arrangement 220 including a single optical fiber 222 and a surrounding coating of microcellular material 224. FIG. 7 illustrates schematically an optical device 226 including multiple optical fibers 228 and a region of microcellular material 230 which surrounds, coats, and separates the optical fibers.

95. FIGS. 8 and 9 illustrate cable arrangements that take advantage of the strength of microcellular material for cable coatings. FIG. 8 illustrates schematically an electrical cable assembly 232 including a plurality of electrical conductors 234, each coated with a layer of insulating material 236 that can be microcellular material. A tube of material 238 surrounds the conductors. Tube 238 can be solid plastic, or foam, in a preferred embodiment, is microcellular polymeric material. At least one of materials 236 and 238 is microcellular, preferably both are microcellular. A microcellular tube 238 can be extruded using a system similar to that illustrated in FIG. 1, but without a wire feed, and of a larger dimension, or a system such as that of FIG. 1 can be used with a central article fed through the crosshead to help shape the tube, followed by removal of the central article. FIG. 9 illustrates an electrical cable assembly 240 including a plurality of conductors 242 each coated with a layer of material 244, a layer of material 246 surrounding the plurality of conductors, and a metal tube 248 surrounding layer 246. At least one of materials 244 and 246 is microcellular, preferably both are microcellular. An outer, polymeric jacket (not shown) can be provided surrounding metal tube 248, which can be microcellular as well.

96. FIG. 10 illustrates a coaxial cable 250 using microcellular material. Cable 250 includes an outer metal tube 252, an inner metal conductor 254, and a microcellular material 256 filling the region between the outer tube 252 and the inner conductor 254. Microcellular material 256 can be extruded over conductor 254 using the system of FIG. 1, followed by assembly of outer metal tube 252 about the microcellular material. An outer, polymeric jacket (not shown) can be provided surrounding metal tube 252, which can be microcellular.

97. FIG. 11 illustrates a twisted pair cable including microcellular material. Twisted pair cable 258 includes two metal conductors 260, each coated with microcellular material 262. The wires coated with microcellular material can be fabricated using the system of FIG. 1, followed by the twisting of the wires to form the twisted pair. It is a feature that twisted pair wires can be made, according to the present invention, preferably without auxiliary coatings to add strength, because of the unexpected strength of the microcellular material coating. Twisted wire pairs having a lay length, twist length, and the like useful for high speed data communication can be provided in accordance with the invention. Twisted pairs having twists-per-inch of a high order required for such applications can be provided. In particular, twisted pairs or multi-twisted, braided wires and the like can be processed using microcellular material of the invention at a twist length from about 0.5 to about 1″. In one set of embodiments twisted wires are provided having a twist length of less than 0.7 inch, preferably less than 0.6 inch, more preferably still less than about 0.55 inch. It is a general assumption in the art that at low twist lengths such as these, using foam insulation on a conductor without a structurally-supporting skin (no “foam-skin” arrangement), the foam will typically collapse, changing the distance from center-to-center of conductors and therefore changing capacitance. The microcellular material of the present invention prevents such collapse.

98. The invention also involves the discovery that microcellular material has, surprisingly, strength required for other electrical applications. FIGS. 12-146 illustrates schematically a variety of electronic devices, including microcellular polymeric materials, and steps in fabrication of such materials. FIG. 12 illustrates schematically a printed circuit board 264, including a sheet of microcellular material 266 and electrically conducting connectors 268 deposited on a top surface 270 of the sheet 266. FIG. 13 illustrates a multi-level circuit board arrangement 270, including a plurality of sheets of microcellular material 272 and 274, with sheet 274 being positioned on a top surface of sheet 272, and a plurality of layers of electrical conducting connections 276 and 278, respectively, each residing on a top surface of sheets 272 and 274, respectively. FIGS. 14a and b illustrate a printed circuit board fabrication technique. FIG. 14a illustrates a printed circuit board arrangement 280 including a sheet of microcellular material 282 coated with a layer of metal 284. FIG. 14b illustrates circuit board 280 after etching to remove selected portions of the metal leaving electrically conductive connections 286 on a top surface of microcellular sheet 282. U.S. patent application Ser. No. 08/777,709 and International Patent Application Serial No. PCT/US97/15088, referenced above, as well as U.S. Pat. No. 5,158,986 (Cha, Adel filed Oct. 27, 1992) incorporated here and by reference, describe the fabrication of microcellular sheet.

99. The function and advantage of these and other embodiments of the present invention will be more fully understood from the examples below. The following examples are intended to illustrate the benefits of the present invention, but do not exemplify the full scope of the invention.

### EXAMPLE 1

### Tandem Wire Extrusion System for Microcellular Material

100. A tandem extrusion line (Akron Extruders, Canal Fulton, Ohio) was arranged including a 2 inch, 32/1 L/D primary extruder and a 2.5 inch, 34/1 L/D secondary extruder. An injection system for injection of CO₂ into the primary was placed at a distance of approximately 20 diameters from the feed section. The injection system included 4 equally-spaced circumferentially, radially-positioned ports, each port including 176 orifices, each orifice of 0.02 inch diameter, for a total of 704 orifices.

101. The primary extruder was equipped with a two-stage screw including conventional first-stage feed, transition, and metering sections, followed by a multi-flighted (four flights) mixing section for blowing agent dispersion. The screw was designed for high-pressure injection of blowing agent with minimized pressure drop between the first-stage metering section and point of blowing agent injection. The mixing section included 4 flights unbroken at the injection ports so that the orifices were wiped (opened and closed) by the flights. At a screw speed of 80 RPM each orifice was wiped by a flight at a frequency of 5.3 wipes per second. The mixing section and injection system allowed for very rapid establishment of a single-phase solution of blowing agent and polymeric material.

102. The injection system included air-actuated control valve to precisely meter a mass flow rate of blowing agent at rates from 0.2 to 12 lbs/hr at pressures up to 5500 psi.

103. The secondary extruder was equipped with a deep channel, three-flighted cooling screw with broken flights, which provided the ability to maintain a pressure profile of microcellular material precursor, between injection of blowing agent and entrance to the point of nucleation (the die, in this case) varying by no more than about 1500 psi, and in most cases considerably less.

104. The system was equipped, at the exit of the secondary extruder, with a 90 degree adapter and transfer tube mounted horizontally to allow a data communications element such as wire to be fed through a Genca Lo Vol™ (Clearwater, Fla.) crosshead mounted at the end of the transfer tube. A die with an exit O.D. of 0.0291 inch was used having a 7 degree included taper. A 0.021 inch diamond tip was used.

105. 24 AWG solid copper wire was fed to the crosshead utilizing a standard payoff system, straightener, and preheater before the crosshead. A cooling trough, nip roll puller, and winder were placed downstream of the crosshead to cool and take up the wire.

106. A bleed valve was positioned in the transfer tube to provide appropriate flow volume control for thin coating of small wire.

### EXAMPLE 2

### Extrusion of Microcellular, Flame-Retardant High-Density Polyethylene Onto 24 AWG Solid Copper Wire

107. Polyethylene pellets (Union Carbide UNIGARD-HP™ DGDA-1412 Natural, 1.14 g/cc) were gravity-fed from the hopper of the primary screw into the extrusion system of Example 1. Primary screw speed was 15 RPM giving a total output (bleed and die) of approximately 15 lbs/hr of microcellular material. Secondary screw speed was 3 RPM. Barrel temperatures of the secondary extruder were set to maintain a melt temperature of 336° F. measured at the end of the secondary extruder. CO₂ blowing agent was injected at a rate of 0.54 lbs/hr resulting in 3.6 wt % blowing agent in the melt. Pressure profile between the injection ports and the inlet of the crosshead was maintained between 3400 and 4040 psi. Approximately 1.2 lbs/hr fluid microcellular material precursor flowed through the crosshead, which could be controlled by adjustment of the bleed valve.

108. FIGS. 15 and 16 are photocopies of SEM images of cross sections of microcellular wire coating, following removal of wire, according to this example, showing substantially uniform cells of approximately 20 microns average size, with maximum cell size of approximately 25 microns. Material density was approximately 0.96 g/cc, and cell density was approximately 40×10⁶ cells/cc. Average coating thickness was approximately 0.005 inch.

### EXAMPLE 3

### Extrusion of Very Thin Microcellular Flame-Retardant Polyolefin Wire Coating onto a 24 AWG Solid Copper Wire

109. Flame-retardant filled polyolefin was extrusion coated onto 24 AWG solid copper wire as an extremely thin, microcellular insulating coating.

110. A tandem extrusion system similar to that of Example 1 was used in this example. The system included a 1.5 inch, 33:1 L/D primary extruder, a 2 inch, 24:1 L/D secondary extruder, a cross-head with a pressure-type die (0.0393 inch diameter), wire payoff, wire preheater, wire straightener, cooling trough, belt capstan type puller, and winder. A desiccating drying hopper was used to pre-condition polymer pellets to remove excess moisture.

111. Flame-retardant filled polyolefin pellets were gravity-fed from the desiccating hopper into the extrusion system. Primary screw speed was 40 RPM giving a calculated mass flow rate of 27.1 lb/hr (no bleed port in use). Secondary screw speed was 8 RPM. Barrel set point temperatures of the secondary extruder were set to maintain a melt temperature of 400° F. (204° C.) at the end of the extruder. CO₂ blowing agent was injected at a rate of 0.1 lb/hr resulting in a 0.9% by polymer weight blowing agent in the material. Pressure profile between the injection ports and the inlet to the cross-head was maintained between 4100 psi and 3600 psi, respectively. The estimated pressure before the die was 1500 psi. The wire line speed was approximately 600 fpm. With a cooling trough initial quench distance of 10 inches from the die exit, a 0.016 inch thick coating of microcellular material, with a density reduction of 48% (calculated material density of nominally 0.73 g/cc) of material was produced. Relocation of the cooling trough initial quench distance to 91 inches from the die exit (under otherwise identical conditions) resulted in a 0.013 inch thick coating with a density reduction of 27% (calculated material density of nominally 1.04 g/cc) of the solid material.

112. FIGS. 17 and 18 are photocopies of SEM images of cross-sections of the resultant 0.016 inch thick microcellular wire coating, following removal of the wire (for ease of creation of the required fracture profile). Cell sizes range from about 8 to about 10 microns in diameter. FIGS. 19 and 20 are photocopies of SEM images of cross-sections of the 0.013 inch thick microcellular wire coating, following removal of the wire. Cell sizes range from about 5 to about 10 microns in diameter.

113. The microcellular wire coatings of this example essentially surround and are secured to the conductor (wire) with no discernable gap between the inner surface of the microcellular coating and the outer surface of the conductor. FIG. 24 is a photocopy of an optical micrograph of a wire coating sample, without wire removed, mounted in epoxy and sectioned to reveal cross-sectional detail of the microcellular coating and wire. The light area in FIG. 24 is the copper conductor and the darker region is the microcellular wire coating.

114. The 0.016 inch thick wire coating samples were subjected, prior to removal of wire, to UL 444 Section 6.2 Crash Resistance Tests and all samples passed.

### EXAMPLE 4

### Extrusion of Very Thin Microcellular Flame-Retardant Polyolefin Wire Coating onto a 24 AWG Solid Copper Wire

115. Flame-retardant filled polyolefin pellets were gravity fed from the hopper into a tandem extrusion system of Example 3. Primary screw speed was 55 RPM giving a calculated mass flow rate of 13.7 lbs/hr onto the wire and 17.8 lbs/hr through a bleed port. Secondary screw speed was set at 11 RPM. Barrel set point temperatures of the secondary extruder were set to maintain a melt temperature of 400° F. (204° C.) at the end of the extruder. CO₂ blowing agent was injected at a nominal rate of 0.1 lbs per hour resulting in 0.7% by polymer weight blowing agent in the material. Pressure profile between the injection ports and the inlet to the cross-head was maintained between 4900 psi and 4100 psi. The estimated pressure before the die was 2000 psi. Wire line speed was approximately 820 fpm. A die with a 0.032 inch diameter was used. With cooling trough initial quench distance of 19 inches from the die exit, a 0.007 inch thick coating of microcellular material with a density reduction of 20% (from the solid material, calculated material density of nominally 1.13 g/cc) was produced.

116. FIGS. 21 and 22 are photocopies of SEM images of cross-sections of the resulting 0.007 inch thick microcellular wire insulating coating, following removal of the wire. Cell sizes range from about 5 to about 10 microns in diameter.

117. FIG. 23 is a photocopy of an optical micrograph of the wire coating sample of this example (without wire removed) mounted in epoxy and sectioned to reveal cross-sectional detail of the microcellular coating and wire (light copper conductor; dark: microcellular wire coating). The coating essentially surrounds and secures the conductor with no discernable gap.

118. The 0.007 inch thick wire coating samples were subjected to the UL 444 Section 6.2 crush resistance test and all samples past. The test was carried out as follows. Five 180 mm samples of straightened insulated wire are each crushed twice between two 50 mm wide flat, horizontal steel plates in a compression machine whose jaws close at the rate of 5.0 plus or minus 0.5 mm/min. The edges of the plates are not sharp. The length of the specimen is parallel to the 50 mm dimension of the plates with 25 mm of the specimen extending outside of the plates at one end of the specimen and 100 mm at the other. The plates are grounded and, together with the specimens, apparatus, and surrounding air, are at thermal equilibrium at 24 plus or minus 8 degrees Centigrade. The plates are moved together with increasing force until a short circuit between the plates and the inner conductor occurs. The maximum force exerted on the specimen before the short circuit occurs is recorded as the crushing force for that end of the specimen. The specimen is then turned end for end, rotated 90 degrees, reinserted from the end opposite the one originally inserted, and crushed. The average of the ten tests is then compared to 200 lbs force for wire with bonded metal shields or 300 pounds force for all other wire to determine whether the wire passes the test.

### EXAMPLE 5

### Extrusion of Thin Microcellular Polyolefin Coating onto a 24 AWG Stranded Copper Wire

119. Two commercially available polyolefin materials were dry blended and were extruded onto 24 AWG stranded copper wire as a thin microcellular insulating coating.

120. A tandem extrusion system similar to that of Example 1 was used in this example. The system included a 1.25 inch 30:1 L/D primary extruder, 1.25 inch 30:1 L/D secondary extruder, a cross-head with a pressure-type die (0.036 inch diameter), wire payoff, wire preheater, wire straightener, cooling trough, and belt-capstan type puller.

121. The polyolefin material pellets were gravity-fed from the hopper into the extrusion system. Primary extruder screw speed was set at 50 RPM giving a calculated mass flow rate of 10 lb./hr. The secondary screw speed was set to maintain a melt temperature of 370° F. (188 ° C.) at the end of the secondary extruder. CO₂ blowing agent was injected at a nominal rate of 0.08 lb./hr resulting in a 0.76% by polymer weight of blowing agent in the material. The pressure profile was maintained relatively constant at 4500 psi from the metering section to the cross-head. The estimated pressure at the entrance to the die was 2300 psi. The wire line speed was set to 518 fpm.

122. A 0.009 inch thick coating of microcellular material (measured at the largest diameter of the strand), with a calculated density reduction of 30% (calculated material density of nominally 0.647 g/cc) was produced. The nominal cell size was 30 microns. The microcellular wire coatings of this example essentially surround the stranded conductor and fill the interstices with no discernable gap between the inner surface of the microcellular coating and the outer surface of the conductor.

123. The 0.009 inch thick wire coating samples were subjected, prior to removal of wire, to the UL 444 Section 6.2 Crush (spelling error in example 3 “Crash” should be “Crush”) Resistance Tests and all samples passed.

### EXAMPLE 6

### Extrusion of Thin Microcellular Polyolefin Coating onto a 24 AWG Stranded Copper Wire

124. The dry-blended polyolefin pellets of example 5 were gravity-fed from the hopper into the extrusion system of example 5. Primary extruder screw speed was set at 50 RPM giving a calculated mass flow rate of 10 lb./hr. The secondary screw speed was set to maintain a melt temperature of 390 ° F. (199 ° C.) at the end of the secondary extruder. CO₂ blowing agent was injected at a nominal rate of 0.08 lb./hr resulting in a 0.76% by polymer weight of blowing agent in the material. The pressure profile was maintained relatively constant at 4300 psi from the metering section to the cross-head. The estimated pressure at the entrance to the die was 2900 psi. The wire line speed was set to 296 fpm.

125. A 0.015 inch thick coating of microcellular material, with a calculated density reduction of approximately 30 was produced. The cell size ranged from 15 to 50 microns. The largest cells located nearest to the conductor.

126. The 0.015 inch thick wire coating samples were subjected, prior to removal of wire, to the UL 444 Section 6.2 Crush (spelling error in example 3 “Crash” should be “Crush”) Resistance Tests and all samples passed.

127. Those skilled in the art would readily appreciate that all parameters listed herein are meant to be exemplary and that actual parameters will depend upon the specific application for which the methods and apparatus of the present invention are used. It is, therefore, to be understood that the foregoing embodiments are presented by way of example only and that, within the scope of the appended claims and equivalents thereto, the invention may be practiced otherwise than as specifically described.

What is claimed is:

1. An article comprising:
a data communications element; and
a coating of microcellular material on a surface of the data communications element, having a maximum thickness of less than about 0.5 mm.

2. An article as in claim 1 wherein the coating passes UL 444 Section 6.2 Crush Resistance Test.

3. An article as in claim 1, wherein the data communications element is an electrical conductor.

4. An article as in claim 1, wherein the data communications element is an electrically-conductive wire and the coating of microcellular material surrounds the exterior surface of the wire.

5. An article as in claim 1, wherein the data communications element is a stranded electrical conductor comprising a plurality of solid conductors twisted or braided together, and the coating of microcellular material surrounds an exterior surface of the stranded conductor.

6. An article as in claim 1, comprising a plurality of electrical conductors and microcellular material coating exterior surfaces of the conductors and filling void spaces between the conductors.

7. An article as in claim 1, wherein the data communications element is an optical fiber and the coating of microcellular material surrounds an exterior surface of the optical fiber.

8. An article as in claim 1, comprising a plurality of optical fibers and microcellular material coating exterior surfaces of the plurality of optical fibers and filling void spaces between the optical fibers.

9. An article as in claim 1, wherein the article comprises a cable assembly including a microcellular polymeric tube and one or more electrically conducting wires coated with microcellular material and inserted into the microcellular polymeric tube.

10. An article as in claim 1, wherein the article comprises a cable assembly including a microcellular polymeric tube; and one or more optical fibers coated with microcellular material and inserted into the microcellular polymeric tube.

11. An article as in claim 1, wherein the article comprises a wire channel including a metal tube whose inside surface is coated with microcellular material and one or more electrical conducting wires coated with microcellular material and inserted into the tube.

12. An article as in claim 1, wherein the article comprises a coaxial cable including an electrically conducting wire coated with microcellular material and an electrically conducting tube into which the electrically conducting wire coated with microcellular material is inserted.

13. An article as in claim 1, comprising a twisted pair cable including at least two electrically conducting wires, each coated with microcellular material, twisted about each other in a helical fashion where each twist is displaced longitudinally down the cable from the previous twist.

14. An article as in claim 1, wherein the article comprises a printed circuit board including a sheet of microcellular polymeric material and electrically conducting materials deposited onto the sheet for the purposes of interconnecting electronic devices.

15. An article as in claim 1, wherein the article comprises a multilevel circuit board including at least two printed circuit boards according to claim 15 placed upon each other so as to form a multilevel circuit board.

16. An article as in claim 1, wherein the article comprises a multilevel circuit board including two or more printed circuit boards according to claim 17 placed upon each other so as to form a multilevel circuit board.

17. An article as in claim 1, wherein the coating has a maximum thickness of less than about 0.25 mm.

18. An article as in claim 1, wherein the microcellular material coating is a coating of microcellular polyolefin.

19. An article as in claim 1, wherein the coating of microcellular material has an average cell size of less than about 30 microns.

20. An article as in claim 1, wherein the coating of microcellular material has an average cell size of less than about 20 microns.

21. An article as in claim 1, wherein the coating of microcellular material has an average cell size of less than about 10 microns.

22. An article as in claim 1, wherein the coating of microcellular material has a maximum cell size of about 50 microns.

23. An article as in claim 1, wherein the coating of microcellular material has a maximum cell size of about 35 microns.

24. An article as in claim 1, wherein the coating of microcellular material has a maximum cell size of about 25 microns.

25. An article as in claim 1, wherein the coating of microcellular material has an average cell size of less than about 30 microns and a maximum cell size of about 50 microns.

26. An article as in claim 1, wherein the coating of microcellular material has an average cell size of less than about 20 microns and a maximum cell size of about 35 microns.

27. An article as in claim 1, wherein the coating of microcellular material has an average cell size of less than about 10 microns and a maximum cell size of about 25 microns.

28. An article as in claim 1, wherein the coating of microcellular material has an average cell size of less than about 5 microns.

29. An article as in claim 1, wherein the coating of microcellular material has a maximum cell size of about 15 microns.

30. An article as in claim 1, wherein the coating of microcellular material is essentially closed-cell.

31. An article as in claim 1, wherein the coating of microcellular material has a moisture absorption of less than about 0.1% by weight based on the weight of the coating after immersion in water for 24 hours.

31. An article as in claim 1, wherein the coating of microcellular has a moisture absorption of essential zero after exposure to 100% relative humidity conditions for 24 hours.

33. An article as in claim 1, wherein the coating of microcellular material has a moisture absorption of less than about 0.25%.

34. An article as in claim 1, wherein the coating of microcellular material has a moisture absorption of less than about 0.5%.

35. An article as in claim 1, wherein the coating of microcellular material consists essentially of a first material and the article is free of any second material, different from the first material, between the microcellular material and the surface of the data communications element.

36. An article as in claim 1, wherein the microcellular material consists essentially of a first material and the article is free of any second material, different from the first material, on an exterior surface of the microcellular material.

37. An article as in claim 1, wherein the data communications element is an electrically-conductive wire and the coating of microcellular material consists essentially of a first material that surrounds the wire and the article is free of any second material, different from the first material, between the microcellular material and the surface of the wire.

38. An article as in claim 1, wherein the data communications element is an electrically-conductive wire and the coating of microcellular material consists essentially of a first material that surrounds the wire and the article is free of any second material, different from the first material, on a surface of the microcellular material.

39. An article as in claim 1, wherein the data communications element is an electrically-conductive wire and the coating of microcellular material surrounds the wire, and the coating is free of any solid layer on an exterior surface thereof at a thickness of greater than about 100 nm.

40. An article as in claim 1, wherein the data communications element is an electrically-conductive wire and the coating of microcellular material surrounds the wire, and the coating is free of any solid layer on an exterior surface thereof at a thickness of greater than about 50 nm.

41. An article as in claim 1, wherein the data communications element is an electrically-conductive wire and the coating of microcellular material surrounds the wire, and the coating is free of any solid layer on an exterior surface thereof at a thickness of greater than about 25 nm.

42. An article as in claim 1, wherein the data communications element is an electrically-conductive wire and the coating of microcellular material surrounds the wire, and the coating is free of any solid layer on an exterior surface thereof at a thickness of greater than about 10 nm.

43. An article as in claim 1, wherein the data communications element is an electrically-conductive wire and the coating of microcellular material surrounds the wire, and the coating is free of any solid layer on an exterior surface thereof at a thickness of greater than about 5 nm.

44. An article as in claim 1, wherein the data communications element comprises an electrically-conductive wire and the coating of microcellular material surrounds the electrically-conductive wire and is secured to the wire.

45. An article as in claim 44, wherein the microcellular material is secured to the wire in the absence of an auxiliary adhesive between the coating and the wire.

46. An article as in claim 1, comprising a twisted pair cable having a twist length from about 0.5 to about 1 inch.

47. An article as in claim 1, comprising a twisted pair cable having a twist length less than about 0.7 inch.

48. An article as in claim 1, comprising a twisted pair cable having a twist length less than about 0.6 inch.

49. An article as in claim 1, comprising a twisted pair cable having a twist length less than about 0.55 inch.
